(19) United States
(12) Patent Application Publication
(10) Pub. No.: US 2011/0042598 A1
(43) Pub. Date: Feb. 24, 2011

(54) Solenoid-actuated diaphragm valve

(76) Inventor: Eugeniusz Kozak, Mount Olive, NJ (US)

Correspondence Address: THOMAS J. GERMINARIO, ESQ., 154 ROUTE 206, CHESTER, NJ, 07930, US

(21) Appl. No.: 12/926,221

(22) Filed: Nov. 3, 2010

Related U.S. Application Data
(63) Continuation-in-part of application No. 12/071,829, filed on Feb. 27, 2008.

(51) Int. Cl. F16K 31/02

(52) U.S. Cl. 251/129.17

(57) ABSTRACT

A solenoid-actuated diaphragm valve achieves minimal dead volume, tolerance of high pressures, prolonged diaphragm life, and energy conservation using a three-sector diaphragm in concert with a constraining plate which confines vertical displacement to the central sectors of the diaphragm.

### REFERENCE TO RELATED APPLICATION

This application is a continuation-in-part of application Ser. No. 12/071,829 filed Feb. 27, 2008.

### FIELD OF THE INVENTION

The present invention relates to valves that control fluid flow by using a flexible diaphragm to seal one or more fluid passages, and more particularly to valves in which the sealing diaphragm is deformed through the application of a biasing force transmitted by the movement of a solenoid armature.

### BACKGROUND OF THE INVENTION

Solenoid-actuated diaphragm valves are widely used in fluid distribution systems to control fluid flow. In isolation valves, the fluid can be isolated and channeled to designated passages and/or chambers within the valve through the displacement of a flexible diaphragm. The displacement of the diaphragm typically causes it to engage or disengage with a valve seat where two or more fluid passages terminate. Typically, in the neutral or de-energized condition, the diaphragm engages the valve seat sufficiently to seal one or more of the fluid passages, thereby interrupting or redirecting the fluid flow through the valve. The neutral bias to maintain the diaphragm in the engaged position is most often provided by a compressed helical spring.

Again in the typical isolation valve, the energized condition is one in which the diaphragm disengages from the valve seat sufficiently to allow fluid to flow between two or more of the passages. The biasing means most often applied to cause the diaphragm to disengage is the armature of an electromechanical solenoid. The solenoid assembly contains a solenoid coil, which typically has an annular cylindrical configuration. A ferromagnetic solid cylindrical armature is slidably positioned in the center of the solenoid coil, such that the armature can move in and out of the center, thereby causing the coil's inductance to increase (as the armature advances further into the center) or decrease (as the armature withdraws further from the center). When the solenoid coil is energized, the armature will experience a force which is proportional to the change in inductance of the coil with respect to the change in position of the armature. Therefore, the force generated by the energized solenoid coil will move the armature to a position that increases the inductance of the coil, i.e., further into the center of the coil.

In isolation valves, the armature is typically a solid cylindrical core of iron or steel referred to a “plunger”. Most often, the distal end of the plunger is connected to the helical spring, the force of which urges the plunger against the diaphragm in the de-energized state, corresponding to the closed position of the valve. In the energized state, the plunger is pulled up into the center of the solenoid coil through a cylindrical cavity known as the “plunger guide”. In this withdrawn position, the plunger may either release its pressure on the diaphragm or pull the diaphragm up with it, in either case thereby disengaging the diaphragm from the valve seat and opening the fluid passages.

While the configuration of the solenoid assembly is fairly standardized for isolation valves, there are a number of possible configurations for the plunger, the diaphragm and the valve seat. The arrangement of these elements will determine the volume of fluid that is retained inside the valve when it is in the closed position—commonly referred to as “dead volume”. Because of the potential for contamination of the fluid and/or corrosion of the valve components, dead volume is undesirable and should be minimized. Another variable that depends on the valve configuration is the degree of deformation of the diaphragm as it flexes between the engaged and disengaged positions. Limited deformation is more desirable because it reduces fatigue of the elastomeric material which can cause diaphragm failure over time. Yet another factor to consider is the length of the plunger stroke—that is, the distance through which the plunger must be withdrawn upward through the plunger guide to effect the disengagement of the diaphragm from the valve seat. A shorter plunger stroke is preferable because it consumes less electrical energy, allows quicker response time, and reduces component wear.

In the prior art, there are several alternate configurations for the plunger, the diaphragm and the valve seat. On one end of the spectrum, we find configurations in which the plunger terminates in a needle valve or poppet structure that engages the valve seat and is surrounded or enclosed by the diaphragm. Examples of such “integral diaphragm” configurations are disclosed in Delaporte et al., U.S. Pat. No. 3,098,635, Huley et al., U.S. Pat. No. 3,429,552, and Gilchrist et al., U.S. Pat. Nos. 5,333,643 and 5,386,849. On the other end of the spectrum, there are configurations in which the plunger is not attached to the diaphragm but merely pushes it against the valve seat in the de-energized state. Such “detached diaphragm” configurations are taught by Holtermann, U.S. Pat. No. 4,944,487, Kazama et al., U.S. Pat. No. 5,470,045, and Sule, U.S. Pat. No. 5,546,987. In Allen, U.S. Pat. No. 4,295,631, the de-energized plunger does not push the diaphragm, but instead closes a pilot valve extending through the center of the diaphragm, thereby creating an unbalanced fluid pressure above the diaphragm which urges it against the valve seat.

There are a host of problems associated with both the “integral diaphragm” and “detached diaphragm” designs. The integral diaphragms, as taught by Delaporte and Huley, involve considerable dead volume, long plunger strokes and severe diaphragm deformation. While Gilchrist avoids these problems, it does so at the cost of a quite constricted fluid passage through the valve seat in the open position, which will retard the fluid flow and create pressure build-up on the diaphragm. As for the detached diaphragm designs, Allen and Sule achieve a short plunger stroke but involve considerable dead volume. While Holtermann and Kazama achieve both a short plunger stroke and minimal dead volume, they rely critically on the alignment of the plunger with the center of the diaphragm, which is likely to deviate over time. Moreover, repeated impact on the plunger on the center of the diaphragm will produce scoring and accelerate fatigue failure over time.

Both Holtermann and Kazama have the additional drawback of employing diaphragms having a uniform cross-sectional area. Such diaphragms must flex upward away from the valve seat when the plunger pressure is withdrawn in the energized state. Because such diaphragms must retain resiliency across their entire cross section, they cannot be thickened to withstand high pressure and are prone to failure when fluid pressure exceeds certain limits. Although Gilchrist teaches a non-uniform diaphragm cross-section, one of the thickened portions of the diaphragm surrounds the periphery of the plunger poppet, where deformation will be most concentrated when the poppet moves downward to engage the valve seat. This is inefficient, since the diaphragm cross-section should be thinnest in the area where most of the deformation occurs.

Yet another detached diaphragm design is disclosed by Kleinhappl, U.S. Pat. No. 5,265,843, but in this case a variable diaphragm cross-section is taught. A thick-walled central section of the diaphragm is surrounded by an annular thin-walled medial “ring” area which deforms when the valve is closed. Surrounding the medial ring area of the diaphragm, in turn, is a thickened peripheral bead designed to be secured between the valve body and the solenoid housing. In this design, the central section of the diaphragm forms an obtuse poppet-like projection that engages the central fluid passage of the valve seat in the de-energized state. As can be seen in FIG. 6, however, the combination of this blunt central projection and the pronounced upward flexing of the medial ring area leaves a considerable dead volume when the valve is closed. This suggests that a better design for a variable cross-section diaphragm would be one in which the medial ring flexes upward in the energized state—that is, when the valve is open rather than closed—so that the expanded area under the upwardly flexed ring relieves pressure and promotes even fluid flow, rather than creating a dead volume.

Shirkhan, U.S. Pat. No. 6,089,538, also discloses a diaphragm having a variable cross-section, with a thickened flat central portion and peripheral sealing bead joined by a thin, flexible medial ring section. This medial ring of the diaphragm is capable of flexing more readily and thus relieving pressure from the central and peripheral sections. But, in order to produce an effective seal, the flat surface of the central portion of the diaphragm requires a specially designed valve seat in which tubes extend from the fluid passages above the surface of the valve seat. Shirkhan does represent an advance over the prior art, however, insofar as it teaches a diaphragm that is neither integral with nor detached from the plunger. Instead, the diaphragm has a threaded post-like structure at the center of its reverse side, by means of which the diaphragm is screwed into a threaded recess in the proximal end of the plunger. This “attached diaphragm” design has distinct advantages, because the diaphragm can now move in secure alignment with the plunger while at the same time having a shape unconstrained by the plunger structure.

It should be noted that in the closed position, the diaphragm may seal either one or both of the fluid passages in the valve seat. In a two-port isolation valve, there are two apertures in the valve seat—a valve seat inlet connecting to the inlet port in the valve body and a valve seat outlet connecting to the outlet port in the valve body. The valve seat inlet can be located at the center of the valve seat, with the outlet at the periphery, or vice versa. If we consider the prior art designs in which the diaphragm seals only the central valve seat inlet/outlet, we find that these designs all have a relatively high dead volume, due to the area left unsealed between the diaphragm and the peripheral valve seat outlet/inlet. Examples of this pattern of high dead volume for “single seal” diaphragms can be seen in Delaporte, Huley, Allen, Kleinhappl, and Sule. On the other hand, prior art designs featuring “double seal” diaphragms, which cover both the valve seat inlet and outlet, tend to have minimal dead volume. Illustrations of the latter are Holtermann, Gilchrist, Kazama, and Shirkhan.

Summarizing the foregoing review of the prior art, the following objectives must be achieved in an optimal solenoid valve design:
1. minimal dead volume in the closed position
2. small displacement of the diaphragm between open and closed positions
3. a short plunger stroke to effect valve opening
4. a diaphragm designed to withstand high pressure

In order to achieve the foregoing objectives, the following design features are imperative:
1. a variable diaphragm cross-section, with thickened central and peripheral areas and thin, flexible medial ring;
2. the center area of the diaphragm is attached to the proximal end of the plunger;
3. the medial ring of the diaphragm flexes upward in the open position;
4. the central area of the diaphragm protrudes downward toward the valve seat;
5. a “double seal” diaphragm seals both the valve seat inlet and outlet in the closed position;
6. the medial ring has minimal width; and
7. the diaphragm is secured so as to minimize the movement of the central area and medial ring.

In all prior art designs, the circumference of the diaphragm is secured between the valve body and the solenoid housing. This has the disadvantage of leaving the diaphragm free to flex vertically across the entire width of the valve seat. In the present invention, on the other hand, the diaphragm is secured from above across its entire peripheral band by a disk-shaped constraining plate. All but the central area of the constraining plate is secured between the valve body and the solenoid housing. In the center of the constraining plate is a circular plate aperture, which matches the circumference of the diaphragm's medial ring. The constraining plate restricts vertical displacement of the diaphragm to the central poppet area and medial ring. Limiting the vertical displacement of the diaphragm in this manner enables a shorter plunger stroke and reduces dead volume.

In the present invention, the diaphragm comprises a rigid, acute central poppet projection, circumferentially surrounded by a thin, flexible, narrow medial ring, which is in turn circumferentially surrounded by a thickened, semi-rigid, wide peripheral band having a narrow circumferential flange that engages a corresponding shallow circumferential notch in the valve seat. The diaphragm of the present invention differs from those taught by the prior art in that the peripheral band is thicker and much wider, extending across about half of the diaphragm's diameter. Conversely, in this invention the medial ring of the diaphragm is thinner and much narrower than in the prior art designs. Moreover, the central projection of the present invention's diaphragm has an acute shape, preferably conical, unlike the obtuse central projections of the prior art diaphragms, such as Huley, Allen, Kleinhappl, Sule, and Shirkhan.

By virtue of the unique diaphragm design of the present invention, the flexing of the medial ring allows the central projection to move up and down rapidly in response to the motion of the plunger shaft, thereby opening and closing the central valve seat inlet/outlet with greater frequency. Meanwhile, the width and thickness of the peripheral band enables it, in conjunction with the medial ring, to seal the peripheral valve seat inlet/outlet with minimal dead volume. The lack of bilateral rigid clamping of the circumference of the diaphragm is compensated, in the closed position, by the pressure of a constraining plate on the reverse side of the peripheral band.

Consequently, the unique features of the present invention enable it to achieve the aims of low dead volume, minimal diaphragm displacement, short plunger stroke, and ability to withstand high pressure, far better than the prior art designs. The many advantages of the present invention will be explained in more detail in the next section.

### SUMMARY OF THE INVENTION

In order to simplify the discussion of the features of the present invention, we will refer to a two-port solenoid valve having a valve seat with a central inlet and a peripheral outlet. This does not imply any limitation of the scope of the present invention, which is applicable to any multi-port solenoid valve and any valve seat configuration.

An object of the present invention is to provide a solenoid-actuated diaphragm valve that minimizes the “dead volume” of fluid that is retained inside the valve when it is in the closed position, thereby reducing the potential for contamination of the fluid and/or corrosion of the valve components.

Another object of the present invention is to provide a solenoid-actuated diaphragm valve that limits the degree of deformation of the diaphragm as it flexes between the engaged and disengaged positions, thereby reducing fatigue of the elastomeric material which can cause diaphragm failure over time.

A further object of the present invention is to provide a solenoid-actuated diaphragm valve that operates with a short plunger stroke, that is, a short distance through which the plunger must be withdrawn upward through the plunger guide to effect the disengagement of the diaphragm from the valve seat, thereby consuming less electrical energy, enabling quicker valve response time, and reducing component wear.

Yet another object of the present invention is to provide a solenoid-actuated diaphragm valve in which the diaphragm can withstand high fluid pressure, and more specifically one in which the diaphragm has a variable cross-section, with a semi-rigid “peripheral band” area that resists fluid pressure and a resilient “ring” area located where flexing is required.

Yet a further object of the present invention is to provide a solenoid-actuated diaphragm valve in which the diaphragm can withstand high fluid pressure, and more specifically one in which the diaphragm has a rigid, acute central poppet projection that extends into the central valve seat inlet in the closed position.

Still another object of the present invention is to provide a solenoid-actuated diaphragm valve in which the resilient “ring” area of the diaphragm flexes upward in the energized state (open position), so that the expanded area under the upwardly flexed ring relieves pressure and promotes even fluid flow, rather than creating a dead volume, as would be the case if the ring flexed upward in the closed position.

Still a further object of the present invention is to provide a solenoid-actuated diaphragm valve in which the semi-rigid “peripheral band” of the diaphragm is secured against vertical deflection in both directions (i.e., up and down), thereby effecting a pressure-resistant seal over the periphery of the valve seat.

These and other beneficial objectives are achieved by the present invention by virtue of the following unique features:

1. A “double seal” diaphragm that seals both the central valve seat inlet and the peripheral valve seat outlet in the closed position and leaves virtually no dead volume. The diaphragm has a post-like poppet stem at the center of its reverse side, by means of which the diaphragm is attached to a recess in the proximal end of the plunger shaft. This “attached diaphragm” design allows the diaphragm to move in secure alignment with the plunger while at the same time having a shape unconstrained by the plunger structure.

2. A variable diaphragm cross-section comprising three functionally different areas: (a) a rigid, acute central poppet projection, preferably conical, which is directly connected to the plunger shaft and where the maximum upward displacement of the diaphragm takes place as the plunger rises in the energized state; (b) a thin, flexible, narrow medial ring, which surrounds the central poppet and enables it to have a greater upward displacement than the diaphragm as a whole; and (c) a thickened, semi-rigid, wide peripheral band, which has a narrow circumferential flange that engages a corresponding shallow circumferential notch in the valve seat.

3. A plunger, comprising: (a) a cylindrical plunger core, made of a ferromagnetic material and slidably positioned within a plunger guide that passes through the center of the solenoid coil; wherein the distal end of the plunger core is engaged by a compressed helical spring which urges the plunger core downward toward the valve seat when the solenoid coil is de-energized; (b) a plunger shaft, which extends from the proximal end of the plunger core and is attached to the diaphragm through a poppet stem that extends from the back of the central poppet; wherein the plunger shaft pulls the central poppet upward away from the valve seat when the solenoid coil is energized and the plunger core is drawn upward.

A cylindrical or disk-shaped, ferromagnetic constraining plate, slidably attached to the plunger shaft; wherein the constraining plate presses downward against the peripheral band of the diaphragm and secures it against upward deflection, and wherein the constraining plate has a central aperture that matches the circumference of the diaphragm's medial ring, thereby permitting the medial ring to flex upward and the central poppet to be pulled upward through the aperture by the plunger shaft when the solenoid coil is energized.

The functional role of the foregoing features will be explicated further by the following drawings and detailed description of the preferred embodiment of the present invention.

### BRIEF DESCRIPTION OF THE DRAWINGS

FIG. 1A is an axial section view of a solenoid-actuated diaphragm valve in accordance with the preferred embodiment of the present invention, which valve is depicted in the closed position (de-energized state).

FIG. 1B is a detail axial section view of the diaphragm and valve seat depicted in FIG. 1A.

FIG. 2A is an axial section view of a solenoid-actuated diaphragm valve in accordance with the preferred embodiment of the present invention, which valve is depicted in the open position (energized state).

FIG. 2B is a detail axial section view of the diaphragm and valve seat depicted in FIG. 2A.

FIG. 3 is an axial section view of the plunger, with the diaphragm and constraining plate attached to the proximal end thereof, and a valve body of a solenoid-actuated diaphragm valve in accordance with the preferred embodiment of the present invention.

### DETAILED DESCRIPTION OF THE PREFERRED EMBODIMENTS

In the following detailed description of the preferred embodiment, it should be understood that the novel features of the present invention relate to the plunger, the constraining plate and the diaphragm, and that the other features described herein are merely typical features of a generic solenoid-actuated diaphragm valve. Therefore, the configuration of the various elements of the valve other than the plunger, the constraining plate and the diaphragm are for illustrative and exemplary purposes only, and are not intended to limit the scope of the present invention. Thus, for example, while a specific configuration of the valve body and valve seat is described herein, this configuration can be varied to according to the desired flow pattern of the valve without impairing the utility or applicability of the present invention.

As used in the following description, the term “proximal” refers to the part of an element oriented toward the base of the valve, while the term “distal” refers to the part of an element oriented toward the top of the valve. Similarly, the terms “up” and “upward” refer to the direction toward the top of the valve, while the terms “down” and “downward” refer to the direction toward the base of the valve.

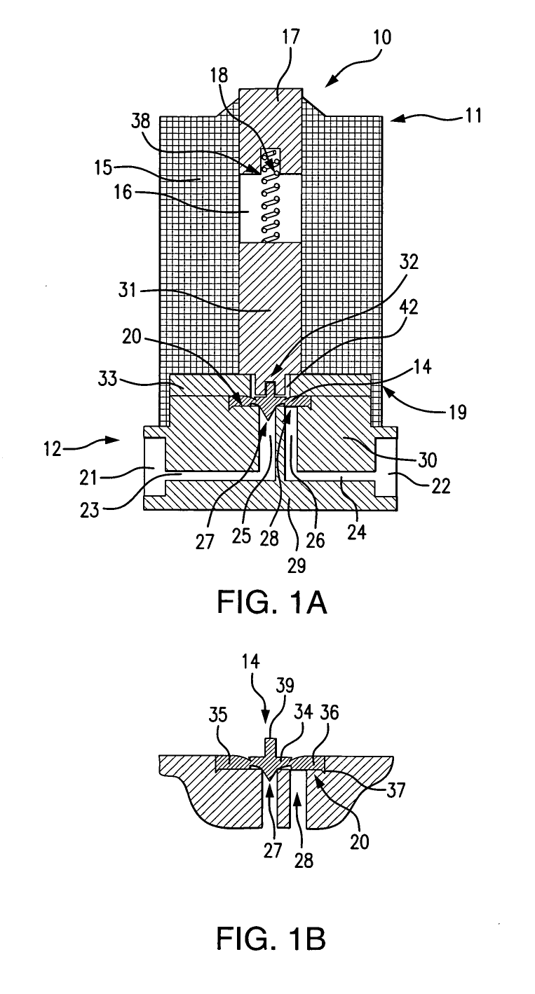

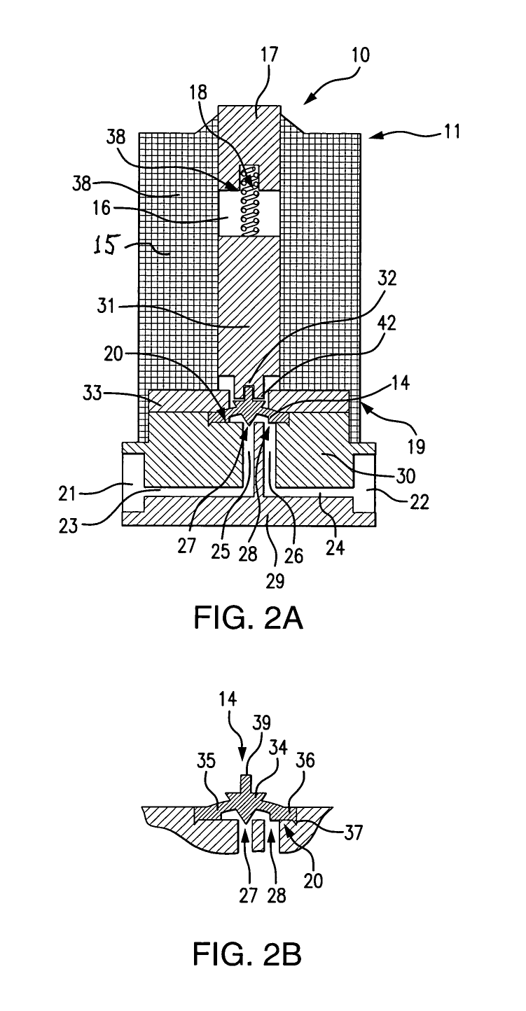

As shown in FIGS. 1A, 1B, 2A and 2B, a solenoid-actuated diaphragm valve according to the preferred embodiment of the present invention 10 comprises a solenoid assembly 11, a valve body 12, a plunger 13, a constraining plate 33, and a diaphragm 14. The solenoid assembly 11 comprises a solenoid coil 15, a plunger guide 16, a solenoid lid 17, a spring 18, and solenoid housing 19. The valve body 12 comprises a valve seat 20, an inlet port 21, an outlet port 22, a radial inlet bore 23, a radial outlet bore 24, an axial inlet bore 25, an axial outlet bore 26, a valve seat inlet 27, a valve seat outlet 28, a valve body base 29, and valve body neck 30.

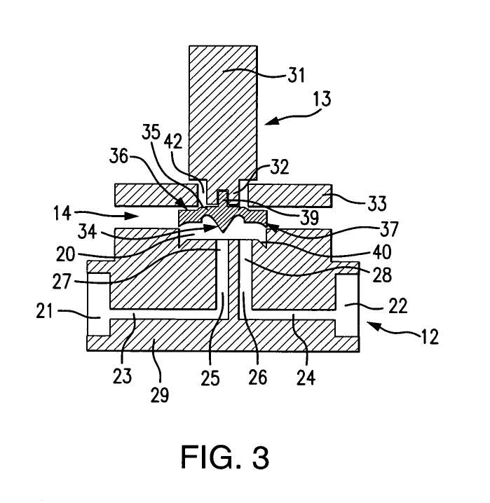

Referring to FIG. 3, the plunger comprises a plunger core 31, and a plunger shaft 32. The constraining plate 33 has a central circular aperture 42 with a circumference which matches the inner circumference of the peripheral band 36 of the diaphragm 14. The diaphragm 14 comprises a central poppet 34, a medial ring 35, a peripheral band 36, and a circumferential flange 37.

The solenoid coil 15 is a coil of wire having an annular cylindrical configuration and surrounding the plunger guide 16, which is a cylindrical passage axially aligned within the solenoid coil 15. At the distal end of the solenoid coil 15 is a solenoid lid 17, which is a short, cylindrical, ferromagnetic plug. The solenoid lid 17 has at its proximal end an axial spring bore 38, into which the distal end of the spring 18 is inserted. The proximal end of the spring 18 engages the distal end of the plunger core 31. Optionally, the proximal end of the spring 18 can be inserted into an axial bore (not shown) in the distal end of the plunger core 31.

The distal end of the solenoid lid 17 is externally threaded so as to screw into an internally threaded frustrum-shaped extension of the distal end of the solenoid housing 19. The solenoid housing 19 is a rigid cylindrical structure that encapsulates all the other components of the solenoid assembly 11. The proximal end of the solenoid housing 19 is internally threaded so as to screw into the externally threaded valve body neck 30.

The valve body neck 30 is a short cylindrical structure integral with the distal end of the valve body base 29 and having a diameter approximately two-thirds that of the valve body base 29. At the center of the distal surface of the valve body neck 30 is the valve seat 20, which is a shallow circular bore, approximately 0.05 to 0.1 cm in depth with a diameter approximately one-third to one-half that of valve body neck 30. Located at the center of the valve seat 20 is the valve seat inlet 27, which is an aperture communicating with the axial inlet bore 25, which in turn communicates with the radial inlet bore 23, which in turn communicates with the inlet port 21, which penetrates the exterior surface of the valve body base 29. Located off-center in the valve seat 20 is the valve seat outlet 28, which is an aperture communicating with the axial outlet bore 26, which in turn communicates with the radial outlet bore 24, which in turn communicates with the outlet port 22, which penetrates the exterior surface of the valve body base 29 on the side opposite to the inlet port 21. The inlet port 21 and outlet port 22 have internal threads for connecting the valve body 12 to external inlet and outlet conduits (not shown) in the conventional manner.

The plunger core 31 is a cylinder of ferromagnetic material which is slidably positioned within the plunger guide 16. The distal end of the plunger core 31 is engaged by the spring 18 which urges the plunger core 31 downward against the valve seat 20 when the solenoid coil 15 is de-energized. The downward pressure of the plunger core 31 acting through the plunger shaft 32 and poppet stem 38, urges the central poppet 34 against the valve seat 20 so as to obstruct the valve seat inlet 27, thereby closing the valve. Extending from the proximal end of the plunger core 31 is the plunger shaft 32, which is attached to the central poppet 34 of the diaphragm 14 by a poppet stem 39. The poppet stem 39 extends upward from the distal end of the central poppet 34 of the diaphragm 14. The plunger shaft 32 pulls the central poppet 34 upward away from the valve seat 20 when the solenoid coil 15 is energized and the plunger core 31 is drawn upward through the plunger guide 16.

Slidably attached to the plunger shaft 32 is the disk-shaped, ferromagnetic constraining plate 33, which presses downward against the peripheral band 36 of the diaphragm 14 and prevents it from deflecting upward when the solenoid coil 15 is energized, thereby keeping the peripheral band 36 securely engaged against the valve seat 20. As shown in FIGS. 2A and 2B, when the solenoid coil is energized, the plunger core 31 moves upward and the central poppet 34 of the diaphragm is drawn upward through the aperture 42 of the constraining plate 33. At the same time, the medial ring 35 of the diaphragm 14 flexes upward through the aperture 42. The upward displacement of the medial ring 35 and the central poppet 34 uncovers the valve seat inlet 27, thereby opening the valve.

As shown in the detail views of FIGS. 1B and 2B, the diaphragm 14 is disk-shaped, fabricated of a resilient elastomeric material, such as PTFE (polytetrafluoroethylene), and it has a variable cross-section comprising three functionally distinct areas. A rigid, acute central poppet 34, preferably conical in shape, is connected through the poppet stem 39 to the plunger shaft 32. When the valve is closed, the central poppet 34 extends down into the valve seat inlet 27, thereby sealing it, as shown in FIG. 1B.

The medial ring 35 surrounds the central poppet 34 and enables it to have an upward displacement while the peripheral band 36 remains stationary. When the valve is opened, as shown in FIGS. 2A and 2B, the maximum upward displacement of the diaphragm 14 takes place at the central poppet 34, as the plunger core 31 moves upward in the energized state. This upward displacement of the central projection 34 is enabled by the deformation of the medial ring 35, which is thin, flexible and narrow.

Surrounding the medial wing 35 in the diaphragm 14 is the peripheral band 36, which is thickened, semi-rigid, and wide. The peripheral band has a narrow circumferential flange 37 that engages a corresponding shallow circumferential notch 40 in the valve seat 20, thereby keeping the diaphragm 14 attached at its circumference to the circumference of the valve seat 20.

While this invention has been described with reference to two specific embodiments, the description is not to be construed in a limiting sense. Various modifications of the disclosed embodiment, as well other embodiments of the invention, will be apparent to persons skilled in the art upon reference to this description. It is therefore contemplated that the appended claims will cover any such modifications or embodiments that fall within the true scope of this invention.

What is claimed is:

1. A solenoid-actuated diaphragm valve, comprising:
a solenoid coil, a plunger, a valve body, a diaphragm, and a constraining plate;
wherein the solenoid coil is switchably connected to a source of electrical current, such that when the electrical current is flowing through the solenoid coil, it is in an energized state, and when the electrical current is not flowing through the solenoid, it is in a de-energized state;
wherein the solenoid coil has a cylindrical interior cavity, within which the plunger is slidably inserted;
wherein the plunger comprises a ferromagnetic cylinder having at its proximal end a plunger shaft;
wherein the plunger is engaged at its distal end by a biasing means, which urges the plunger downward through the interior cavity;
wherein the plunger is drawn upward through the interior cavity when the solenoid coil is in the energized state;
wherein the valve body comprises two or more flow passages, which communicate with each other through a valve seat;
wherein the diaphragm comprises an inverted-conical central poppet, a narrow, thin, resilient medial ring that circumferentially surrounds the central poppet, and a broad, annular, semi-rigid peripheral band, which has an outer circumference and an inner circumference that surrounds the medial ring;
wherein the diaphragm further comprises a poppet stem which extends upward from the distal side of the central poppet and is attached to the proximal end of the plunger shaft;
wherein the constraining plate contains a central aperture, which has a circumference that matches the inner circumference of the peripheral hand of the diaphragm;
wherein the constraining plate is rigidly secured between the proximal end of the solenoid coil and the distal end of valve body, and the central aperture is aligned with the interior cavity of the solenoid coil, and the plunger shaft extends through the central aperture in the de-energized state;
wherein the distal face of the constraining plate engages the proximal face of the peripheral band of the diaphragm from the inner circumference to the outer circumference of the peripheral band, thereby preventing any vertical displacement of the peripheral band, but the constraining plate does not engage either the central poppet or the medial ring of the diaphragm;
wherein the central poppet and the medial ring of the diaphragm are aligned with the central aperture of the constraining plate, and vertical displacements of the central poppet and medial ring are constrained only by the vertical displacement of the plunger and the plunger shaft;
wherein, in the de-energized state, the plunger shaft, acting downward through the poppet stem, causes the central poppet of the diaphragm to engage the valve seat, so as to block communication between two or more of the flow passages; and
wherein, in the energized state, the plunger shaft, acting upward upon the poppet stem, causes the medial ring of the diaphragm to flex upward through the central aperture of the constraining plate and draws the central poppet of the diaphragm upward through the central aperture of the constraining plate, thereby causing the central poppet to disengage from the valve seat, so as to enable communication between two or more of the flow passages.

2. The solenoid-actuated diaphragm valve according to claim 1, wherein the proximal face of the outer circumference of the peripheral band has one or more circumferential flanges that fit snugly into one or more corresponding circumferential notches in the valve seat, thereby securing the outer circumference of the peripheral band to the valve seat.

3. The solenoid-actuated diaphragm valve according to claim 2, wherein the biasing means is a spring.
